(19) United States
(12) Patent Application Publication
(10) Pub. No.: US 2024/0232677 A9
(43) Pub. Date: Jul. 11, 2024

(54) MOVEMENT OF OPERATIONS BETWEEN CLOUD AND EDGE PLATFORMS

(71) Applicant: Dell Products L.P., Round Rock, TX (US)

(72) Inventors: Subhasis Bandyopadhyay, Bangalore (IN); Parminder Singh Sethi, Ludhiana (IN)

(21) Appl. No.: 17/968,944

(22) Filed: Oct. 19, 2022

(51) Int. Cl. G06N 20/00

(52) U.S. Cl. CPC G06N 20/00

(57) ABSTRACT

Techniques are disclosed for moving operations between cloud and edge platforms. For example, a method comprises executing a machine learning algorithm on a cloud platform and analyzing results of executing the machine learning algorithm. Based at least in part on the analysis, a determination is made whether the machine learning algorithm should be additionally trained. Based at least in part on a negative determination further execution of the machine learning algorithm is transferred from the cloud platform to an edge platform.

### FIELD

The field relates generally to information processing systems and, more particularly, to management of operations between cloud and edge platforms.

### BACKGROUND

An edge computing architecture moves at least a portion of data processing to the periphery of a network to be closer to a data source rather than to a centralized location, e.g., cloud platform. For example, instead of transmitting raw data to a cloud platform to be processed and analyzed, such tasks or workloads are performed at or near locations where the data is actually generated. In this manner, for example, network parameters such as bandwidth can be increased, while processing, storing and network parameters such as latency and congestion can be reduced, thus improving overall system performance.

Data processing at edge locations can result in reduced turnaround time, reduced cost, increased control, improved privacy and security, and more efficient use of compute resources when compared to data processing operations sent to and performed by a cloud platform. For example, sending large amounts of data over a network to a cloud platform for data analysis may consume large amounts of network bandwidth. Additionally, there may be data privacy and security issues with sending data to the cloud, as personally identifiable information (PII) and other sensitive information may be compromised. At times, a situation such as, for example, a health-related event, may demand immediate action, and a delay caused by sending data over a network to a cloud platform for analysis and remedial action can have serious consequences.

### SUMMARY

Illustrative embodiments provide techniques for moving operations between cloud and edge platforms. For example, in one embodiment, a method comprises executing a machine learning algorithm on a cloud platform and analyzing results of executing the machine learning algorithm. Based at least in part on the analysis, a determination is made whether the machine learning algorithm should be additionally trained. Based at least in part on a negative determination further execution of the machine learning algorithm is transferred from the cloud platform to an edge platform.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

Advantageously, illustrative embodiments provide techniques for using machine learning to predict whether operations should be reallocated to the edge from the cloud. In more detail, before determining whether to move operations to an edge platform, the illustrative embodiments: (i) determine whether machine learning models have been sufficiently trained; and (ii) analyze operational data to determine amounts of data being processed and a frequency of incoming requests for analysis.

These and other features and advantages of embodiments described herein will become more apparent from the accompanying drawings and the following detailed description.

### BRIEF DESCRIPTION OF THE DRAWINGS

FIG. 1 is a block diagram of an information processing system configured for managing whether operations are performed at edge or cloud platforms in an illustrative embodiment.

FIGS. 2A-2C are block diagrams illustrating stages for movement of operations from a cloud platform to an edge platform in an illustrative embodiment.

FIG. 3 is a block diagram of a serviceability prediction engine in an illustrative embodiment.

FIG. 4 is a graph illustrating a learning curve for training of a machine learning model for an operation in an illustrative embodiment.

FIG. 5 is a graph illustrating learning curves for training of machine learning models for two operations in an illustrative embodiment.

FIG. 6 is a table illustrating example factors considered when moving operations between a cloud platform and an edge platform in an illustrative embodiment.

FIG. 7 is a block diagram of an orchestration engine in an illustrative embodiment.

FIG. 8 is a block diagram illustrating an operational flow for predicting whether to move operations from a cloud platform to an edge platform with a confidence score in an illustrative embodiment.

FIG. 9 is a table illustrating example operations and corresponding predictions and confidence scores for whether to move the operations from a cloud platform to an edge platform in an illustrative embodiment.

FIG. 10 is a flow diagram of an exemplary process for managing whether operations are performed at edge or cloud platforms in an illustrative embodiment.

FIGS. 11 and 12 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising edge computing, cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

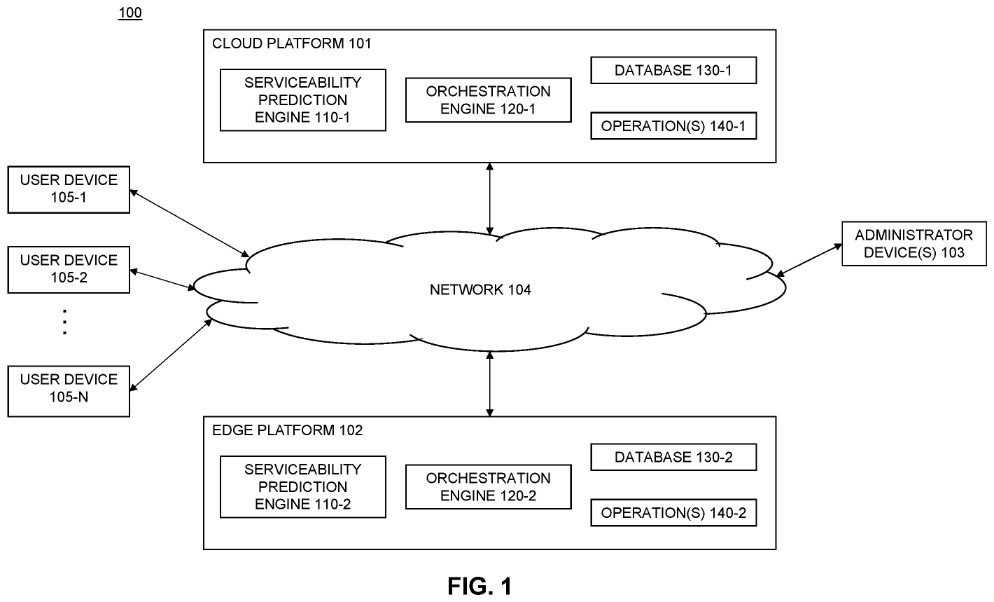

FIG. 1 shows an information processing system 100 configured in accordance with an illustrative embodiment for managing whether operations are performed at edge or cloud platforms. The information processing system 100 comprises a cloud platform 101, an edge platform 102, one or more administrator devices 103, and user devices 105-1, 105-2, . . . 105-N (collectively, user devices 105). The cloud platform 101, edge platform 102, administrator devices 103 and user devices 105 are connected to network 104 and may communicate with each other over the network 104.

The cloud platform 101 may comprise, for example, a data center including a plurality of devices such as, but not necessarily limited to, desktop, laptop or tablet computers, servers, storage devices or other types of processing devices capable of processing operations (also referred to herein as “workloads”). Similarly, the edge platform 102 also comprises a plurality of devices such as, but not necessarily limited to, Internet of Things (IoT) devices, desktop, laptop or tablet computers, mobile telephones, servers, storage devices or other types of processing devices capable of processing workloads. The administrator devices 103 and/or user devices 105 may be devices from which operations originate and/or are sent. The operations include, for example, service requests, tasks, jobs, programs, applications, etc. The administrator devices 103 and user devices 105 also comprise, for example, IoT devices, desktop, laptop or tablet computers, mobile telephones, servers, storage devices or other types of processing devices capable of processing workloads. The devices of the cloud and edge platforms 101 and 102, the administrator devices 103 and the user devices 105 are examples of what are more generally referred to herein as “processing devices.” Some of these processing devices are also generally referred to herein as “computers.” The devices of the cloud and edge platforms 101 and 102, the administrator devices 103 and the user devices 105 may also or alternately comprise virtualized computing resources, such as virtual machines (VMs), containers, etc. The devices of the cloud and edge platforms 101 and 102, the administrator devices 103 and the user devices 105 in some embodiments comprise respective computers associated with a particular company, organization or other enterprise. The variables K, L and N are assumed to be arbitrary positive integers greater than or equal to one.

The terms “client,” “customer,” “administrator” or “user” herein are intended to be broadly construed so as to encompass numerous arrangements of human, hardware, software or firmware entities, as well as combinations of such entities. Compute and/or storage services may be provided for users under a Platform-as-a-Service (PaaS) model, an Infrastructure-as-a-Service (IaaS) model, a Function-as-a-Service (FaaS) model, a Containers-as-a-Service (CaaS) model and/or a Storage-as-a-Service (STaaS) model, including cloud-based PaaS, IaaS, FaaS, CaaS and STaaS environments, although it is to be appreciated that numerous other cloud infrastructure arrangements could be used. Also, illustrative embodiments can be implemented outside of the cloud infrastructure context, as in the case of a stand-alone computing and storage system implemented within a given enterprise.

Although not explicitly shown in FIG. 1, one or more input-output devices such as keyboards, displays or other types of input-output devices may be used to support one or more user interfaces to the devices of the cloud and edge platforms 101 and 102, the administrator devices 103 and the user devices 105, as well as to support communication between the devices of the cloud and edge platforms 101 and 102, the administrator devices 103 and the user devices 105 and/or other related systems and devices not explicitly shown.

Users may refer to customers, clients and/or administrators of computing environments for which management of operations at edge or cloud platforms is being performed. For example, in some embodiments, the administrator devices 103 are assumed to be associated with repair technicians, system administrators, information technology (IT) managers, software developers, release management personnel or other authorized personnel configured to access and utilize the cloud and/or edge platforms 101 and/or 102.

The network 104 may be implemented using multiple networks of different types. For example, the network 104 may comprise a portion of a global computer network such as the Internet, although other types of networks can be part of the network 104 including a wide area network (WAN), a local area network (LAN), a satellite network, a telephone or cable network, a cellular network, a wireless network such as a WiFi or WiMAX network, a storage area network (SAN), or various portions or combinations of these and other types of networks. The network 104 in some embodiments therefore comprises combinations of multiple different types of networks each comprising processing devices configured to communicate using Internet Protocol (IP) or other related communication protocols.

As a more particular example, some embodiments may utilize one or more high-speed local networks in which associated processing devices communicate with one another utilizing Peripheral Component Interconnect express (PCIe) cards of those devices, and networking protocols such as InfiniBand, Gigabit Ethernet or Fibre Channel. Numerous alternative networking arrangements are possible in a given embodiment, as will be appreciated by those skilled in the art.

The workloads (e.g., operations) provided by the user devices 105 comprise, for example, data and applications running as single components or several components working together, with the devices of the cloud and edge platforms 101 and 102 providing computational resources to complete tasks of the workloads. For example, an operation/workload may include a request to execute one or machine learning algorithms to achieve a result. In some embodiments, the result can be related to the performance of a service (e.g., predicting or recommending actions for device management, technical support, medical procedures, financial services, commercial services, etc.). The size of a workload may be dependent on the amount of data and applications included in a given workload.

As can be seen in FIG. 1, a cloud platform 101 comprises a serviceability prediction engine 110-1, an orchestration engine 120-1, a database 130-1 and one or more operations 140-1 being executed on the cloud platform 101. Similarly, an edge platform 102 comprises a serviceability prediction engine 110-2, an orchestration engine 120-2, a database 130-2 and one or more operations 140-2 being executed on the edge platform 102. The embodiments utilize the serviceability prediction engines 110-1 and 110-2 and orchestration engines 120-1 and 120-2 at cloud and edge platforms 101 and 102 to analyze whether various operations can be moved from the cloud platform 101 to the edge platform 102 or vice versa. In one or more embodiments, processing to determine whether operations can be moved (e.g., from a cloud platform 101 to an edge platform 102) runs as background jobs on the cloud and edge platforms 101 and 102. Although one cloud platform 101 and one edge platform 102 are shown in FIG. 1, the embodiments are not necessarily limited thereto, and multiple similarly configured cloud and edge platforms can be part of the information processing system 100 such that operations can be moved between the multiple similarly configured cloud and edge platforms.

The orchestration engines 120-1 and 120-2 work with each operation synchronously to share data with each other. In illustrative embodiments, smart contracts are implemented to control and manage the parameters for data sharing (e.g., types of data shared, access rights to the data, amount of data shared, receiving and transmitting parties, security, etc.). A smart contract is an application that executes logic to exchange data, deliver services and/or unlock protected content. In illustrative embodiments, the smart contracts are stored as part of a blockchain or other distributed ledger technology. The smart contracts programmatically execute logic in response to designated conditions. The logic performs various tasks, processes or transactions that have been programmed into the smart contracts. In some embodiments, the smart contract is executed on a special-purpose VM that is a component of a blockchain or other type of distributed ledger. As explained in more detail herein, smart contracts facilitate sharing by the orchestration engines 120-1 and 120-2 of an operational data matrix comprising information about different operations on the cloud and edge platforms 101 and 102.

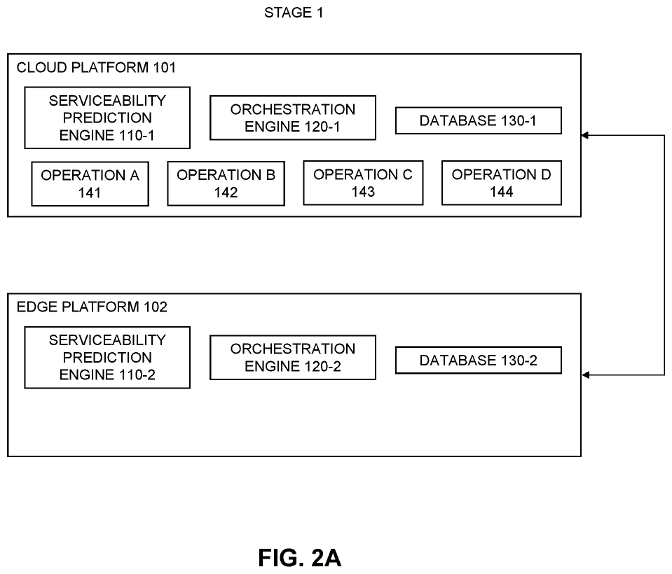

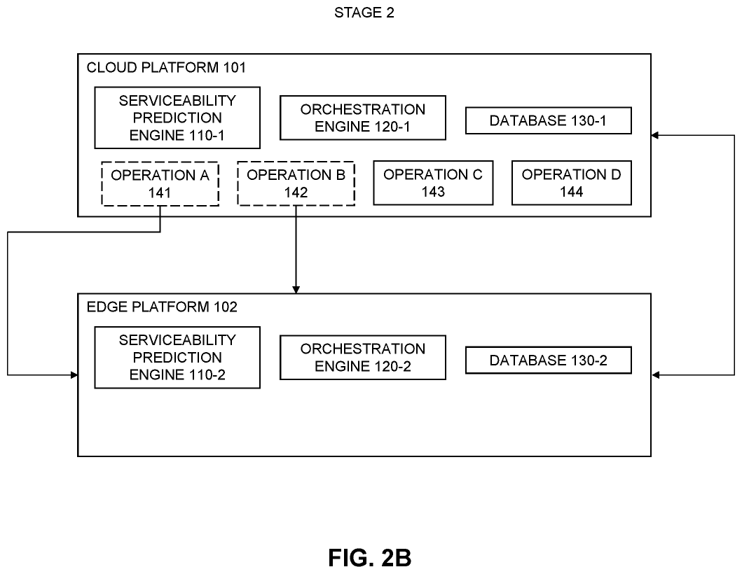

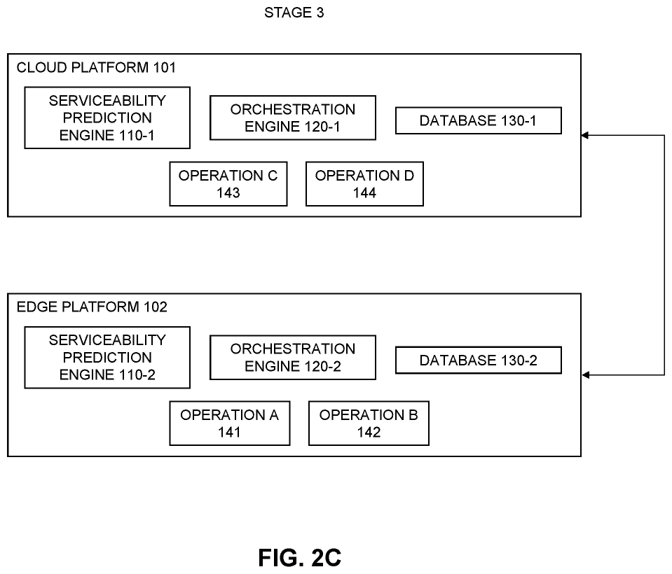

Referring to FIGS. 2A, 2B and 2C, for purposes of explanation, the analysis and movement of operations from a cloud platform 101 to an edge platform 102 in accordance with illustrative embodiments is described in connection with four operations and occurs in three stages. The orchestration engines 120-1 and 120-2 for the cloud and edge platforms 101 and 102 share operational data with each other. Such operational data can include, but is not necessarily limited to, the referenced operational data matrix comprising information about a status of different operations on the cloud and edge platforms 101 and 102, resource usage details (e.g., central processing unit (CPU) capacity, memory capacity and/or storage capacity available and/or being used at the cloud and edge platforms 101 and 102), requests for transfer of operations, responses to requests for transfer of operations, etc.). Data shared between orchestration engines 120-1 and 120-2 may be stored in databases 130-1 and 130-2.

Referring to FIG. 2A, as part of Stage 1, all of the operations (Operation A 141, Operation B 142, Operation C 143 and Operation D 144) are deployed in the cloud platform 101. Based on a recommendation of the serviceability prediction engine 110-1 of the cloud platform 101, one or more of the operations 141-144 and the corresponding execution of same, are moved from one location (e.g., cloud platform 101) to another location (e.g., edge platform 102). For example, referring to FIG. 2B, in Stage 2, based on a recommendation of the serviceability prediction engine 110-1 of the cloud platform 101, Operations A and B 141 and 142 are moved to the edge platform 102 from the cloud platform 101. Movement of an operation may comprise, for example, transfer of the programming logic (e.g., applications and other software) corresponding to the operation from a source location to a destination location so that the operation can be executed at the destination location. For example, according to illustrative embodiments, in the case of an operation comprising a machine learning algorithm, the logic for executing the machine learning algorithm, for receiving requests to execute the machine learning algorithm, for evaluating operation (e.g., accuracy) of the machine learning algorithm and for outputting results from the machine learning algorithm is transferred from the cloud platform 101 to the edge platform 102. The transfer can be executed by the orchestration engines 120-1 and 120-2 using one or more smart contracts. Referring to FIG. 2C, in Stage 3, operations A and B 141 and 142, once transferred, process data and/or requests at the edge platform 102.

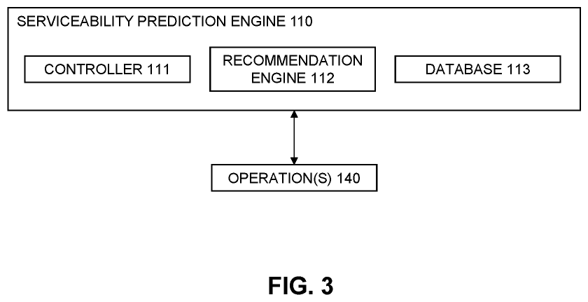

A serviceability prediction engine 110-1 or 110-2 is configured to analyze operational data to determine a state of a deployed operation and predict whether the operation should be relocated to a different location. As described in more detail herein, the analysis may include using one or more machine learning models to make the prediction. For example, according to illustrative embodiments, the serviceability prediction engine 110-1 of the cloud platform 101 analyzes operational data of a given operation (e.g., one of Operations A-D 141-144) to determine a state of the given operation and predict whether the given operation should be relocated to the edge platform 102 from the cloud platform 101. Referring to FIG. 3, a serviceability prediction engine 110 (which may be serviceability prediction engine 110-1 or 110-2) comprises a controller 111, a recommendation engine 112 and a database 113. The controller 111 communicates with the operation(s) 140 to make determinations about the context of a given operation and its functionality. The controller 111 forwards the determinations to the recommendation engine 112, which calculates the beta value of each operation. As described in more detail herein, in the case of an operation utilizing a machine learning algorithm, the beta value indicates whether there is a need for additional training of the machine learning operation. The beta value determination is based on data corresponding to the execution of the machine learning algorithm that is collected by the orchestration engine 120-1 or 120-2. For example, in illustrative embodiments, the beta value is computed based on incoming datasets and predictions generated by a machine learning algorithm when analyzing the incoming datasets.

For example, in keeping with the illustrative example of determining whether to move execution of an operation from the cloud platform 101 to the edge platform 102, the orchestration engine 120-1 collects operational data at designated intervals (e.g., periodically) from the operations being performed by the cloud platform 101. The following are three elements in an operational data matrix that is generated by serviceability prediction engine 110-1 based on the collected operational data by the orchestration engine 120-1.
Operational Data Matrix=
{
“learning curve”: . . . ,
“Average frequency of request”: . . . ,
“Average amount of data processed”: . . . ,
}

The recommendation engine 112 of the serviceability prediction engine 110-1 predicts whether an operation should be moved from the cloud platform 101 to the edge platform 102 based on the operational data matrix. Based on the output of the recommendation engine 112, the controller 111 provides an output to the orchestration engine 120-1 indicating whether the operation should be moved from the cloud platform 101 to the edge platform 102. The operational data analyzed by a serviceability prediction engine 110 and the results of the analysis may be stored in a corresponding database 113.

Learning Curve of an Operation

In the illustrative embodiments, each machine learning algorithm goes through a learning phase where the machine learning algorithm is trained. The learning phase can last for different periods of time (e.g., months, weeks, days, etc.) depending on the complexity of the algorithm and the availability of a meaningful dataset in a live environment. A more complex algorithm will require a longer learning phase. Additionally, the time to train may be extended if meaningful training datasets are not readily available. Since learning uses a large amount of compute resources, the embodiments provide techniques to understand the learning curve of an operation and determine when to end training of a machine learning algorithm. If the training of the algorithm is halted before an optimal time, then the model will not have learned for the required time from different datasets, leading to a loss of important features in the training set and a poorly fitted solution. However, if training is halted after an optimal time, then the training set results in high performance of the model, but increases the time to deploy the model without a significant increase in learning.

By generating and analyzing a learning curve, the serviceability prediction engine 110-1 determines when training of a machine learning algorithm can be stopped. In other words, the serviceability prediction engine 110-1 determines when a given machine learning algorithm no longer requires additional training. By applying the law of diminishing returns, the serviceability prediction engine 110-1 determines a stopping point for training at the stage where incremental learning has decreased, and learning is considered matured rather than overfitting the model. Once learning is considered matured, the recommendation engine 112 may recommend that an operation utilizing the machine learning algorithm be hosted at the edge platform 102 rather than the cloud platform 101. The recommendation of whether to move the operation to the edge platform 102 may also be based on additional factors described in more detail herein.

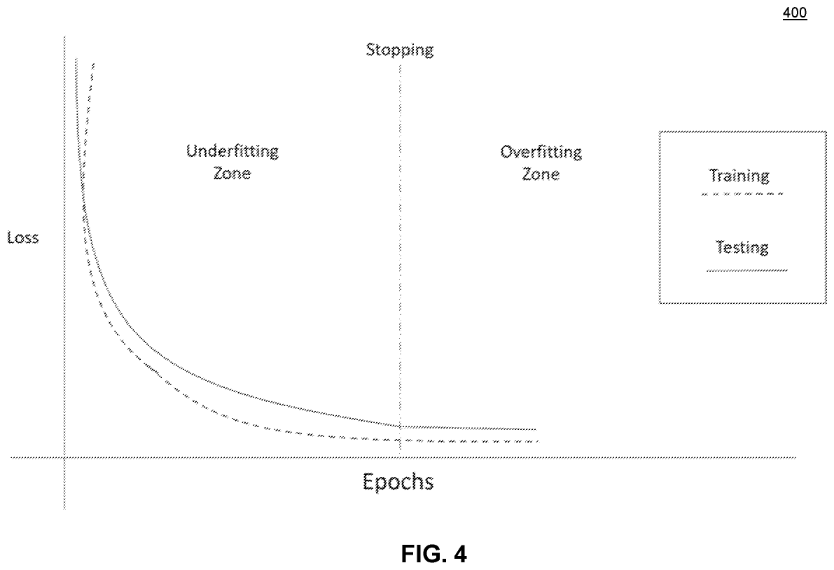

Referring to the graph 400 in FIG. 4, the serviceability prediction engine 110-1 computes a prediction error (loss) of the machine learning model over a period of time (measured in epochs) for training and testing datasets. For example, “loss” is a scalar value referring to the falseness of a prediction made by the machine learning algorithm. As used herein, an “epoch” refers to a time period for training a machine learning model with all available training data for one cycle. In illustrative embodiments, depending on the nature of the machine learning model, the serviceability prediction engine 110-1 of the cloud platform 101 adjusts the value of epochs. For each operation deployed in the cloud platform, the serviceability prediction engine 110-1, via the orchestration engine 120-1, collects operational data used for training and testing and generates the learning curve. The learning curve comprises curves for training and testing datasets and is used to determine the point where the learning can be stopped (labeled “stopping” in FIG. 4). The stopping point on the learning curve corresponds to a point where the machine learning algorithm is between underfitting and overfitting the training dataset (e.g., between an underfitting zone and an overfitting zone). Once this point is identified, the recommendation engine 112 concludes that further learning is no longer required, and the operation would be eligible to move from the cloud platform 101 to the edge platform 102. With each periodic collection of the operational data by the orchestration engine 120-1, the understanding of the learning state of the operation by the serviceability prediction engine 110-1 improves.

As shown in the graph 400, at first, loss for both training and testing datasets decreases. The testing error starts to flatten out at a certain point even though the training error continues to decrease. The point where the validation error starts to increase is when the model would begin overfitting the training set and cease generalizing new data correctly (labelled “stopping” on the graph 400). The purpose of the test dataset is to determine how the machine learning algorithm behaves on a dataset on which it not been trained.

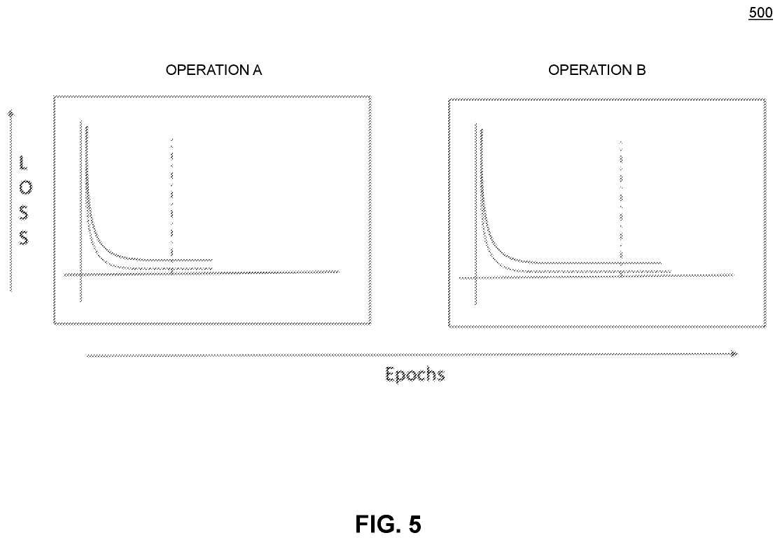

Referring to the graph 500 in FIG. 5, learning curves for different operations (Operation A and Operation B) are shown. As can be understood, the serviceability prediction engine 110-1 generates respective learning curves for respective operations being performed by the cloud platform 101. As shown, the stopping point for learning can be different for different operations. The rate of maturity of a machine learning model differs between operations and may be contingent on a variety of factors including, but not necessarily limited to, data type, types and complexity of machine learning techniques being used and data availability. For example, the value of the epochs may be different for Operation A and Operation B. As can be seen, Operation B requires more epochs to hit the stopping point than Operation A.

Average Frequency of Request and Average Amount of Data Processed

According to illustrative embodiments, when determining whether an operation should be hosted at the edge platform 102 instead of the cloud platform 101, the serviceability prediction engine 110-1 considers how frequently requests are being received for an operation (e.g., requests from user devices 105), and how much data is being processed by the operation. The controller 111 collects the operational data corresponding to request frequency and amount of data being processed from the operations at designated intervals (e.g., in a periodic manner). The intervals may be set to a default value (e.g., every 2 hours), which can be changed by a user. Using this operational data detailing how frequently requests are being received for an operation, and how much data is being processed by the operation, the serviceability prediction engine 110-1 derives a usability factor of the operation. A higher usability factor (e.g., higher frequency of requests and higher amounts of data being processed) increases the likelihood of moving a service to the edge platform 102 than a lower usability factor. For example, if two operations have the same stopping point for training on a learning curve, the operation that is processing more data and receiving requests at a higher frequency would have priority to be moved to the edge platform 102 over the operation with the lower usability factor. The embodiments therefore factor the demand for the operation into the decision to move an operation to an edge location.

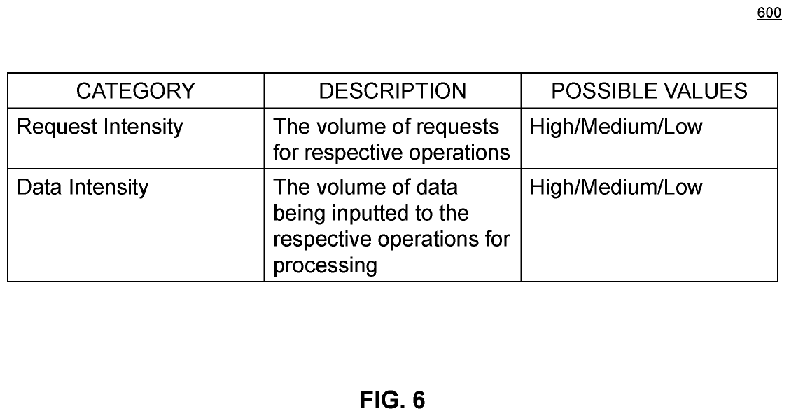

FIG. 6 depicts a table 600 illustrating the factors of request and data intensity considered when moving operations between a cloud platform 101 and an edge platform 102. As noted in the table 600, the request intensity refers to the volume of requests for respective operations, and the data intensity refers to the volume of data being inputted to respective operations for processing. The possible values for each may be, for example, high, medium and low.

In some embodiments, the recommendation engine 112 is trained with various datasets of request frequency and volume of data being processed labelled with corresponding usability factors. Policies may also be added to the recommendation engine 112 by, for example, an administrator via one or more administrator devices 103. For example, a policy may specify that data volume be given higher weight than request frequency or vice versa. The embodiments provide for administrator configurable policies, which can be applied to all operations equally or vary from operation to operation. If varied between operations, operation specific configurations are tagged with particular operation to which they correspond.

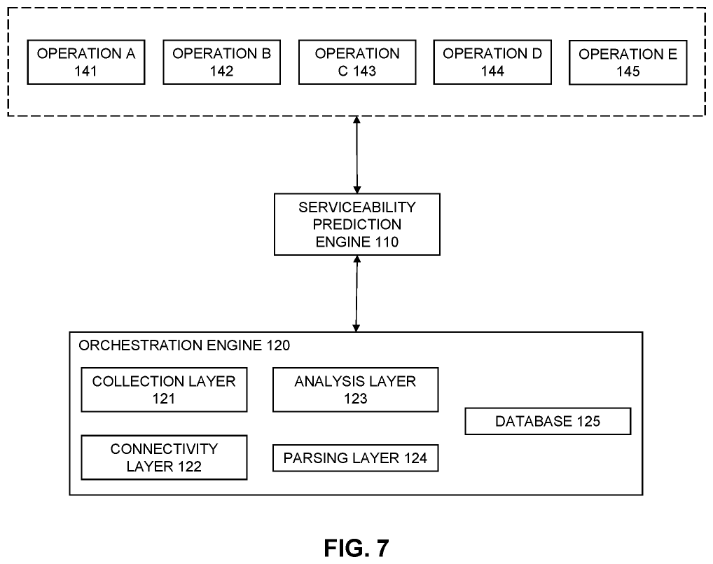

Referring to FIG. 7, an orchestration engine 120 (which may correspond to orchestration engine 120-1 or 120-2) includes a collection layer 121, a connectivity layer 122, an analysis layer 123, a parsing layer 124 and a database 125. The collection layer 121 of orchestration engine 120 collects the operational data of multiple operations (e.g., Operation A 141, Operation B 142, Operation C 143, Operation D 144 and Operation E 145) through a channel in the serviceability prediction engine 110. The collected operational data is stored in database 125 and is accessible for further analysis. The parsing layer 124 receives the collected operational data from the collection layer and converts the collected data into a format that can be processed by an orchestration engine 120 running at another location (e.g., edge platform 102 instead of cloud platform 101 or vice versa). The parsing layer 124 is loaded with pre-defined rules to parse the operational data and store the operational data in formats readable by other orchestration engines 120 at different locations. For example, the pre-defined rules may be based on vendor, and may be trained and tested prior to their use. The analysis layer 123 accesses the data from the database 125 and performs an analysis of the data using pre-defined and dynamically trained policies. The communication between orchestration engines 120 or with other components is performed through the connectivity layer 122, which may implement one or more smart contracts.

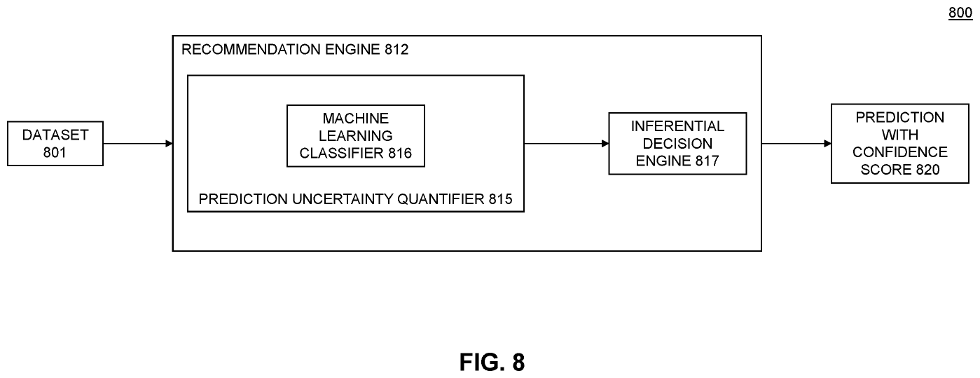

FIG. 8 illustrates an operational flow 800 for predicting whether to move operations from a cloud platform (e.g., cloud platform 101) to an edge platform (e.g., edge platform 102). The output prediction 820 in FIG. 8 includes a confidence score. FIG. 8 illustrates an embodiment of a recommendation engine 812, which may be the same as or similar to the recommendation engine 112 discussed herein. The recommendation engine 812 receives and analyzes a dataset 801 and runs the input through a conformal prediction (CP) model, which is part of a prediction uncertainty quantifier 815. The CP framework, in conjunction with an inferential decision engine 817 is used on top of a machine learning classifier 816 to predict the location (e.g., cloud platform 101 or edge platform 102) for a given operation with a reliable measure of confidence.

Conformal prediction provides multi-value prediction regions. Given a pattern X_i and its significance level ϵ, with “a” as the conformal predictor, a prediction region Γ□(ϵ/i) is provided with probability 1−ϵ. A confidence value represents an indication of a quality of a prediction. In one or more embodiments, a credibility measure is also considered, which indicates a quality of the data on which a decision is being based. The credibility factor provides a mechanism with which some predictions may be rejected. A conformity measure is a function that assigns a conformity score to every sample in the dataset 801. A conformity score defines how well a sample in the dataset 801 conforms to the rest of the dataset 801. Using conformal prediction, the illustrative embodiments formulate a confidence factor, which provides a value of confidence for the determination of whether an operation can be moved from one location to another location (e.g., from cloud platform 101 to edge platform 102).

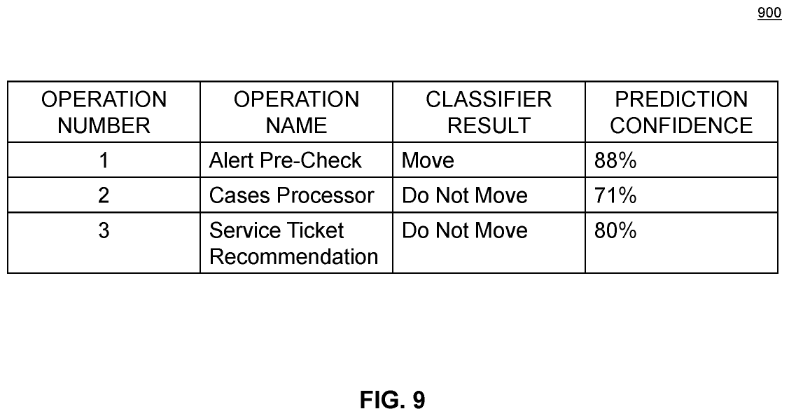

Referring to the table 900 in FIG. 9, example operations, corresponding predictions (e.g., classifier result) and confidence scores are shown for whether to move the operations from the cloud platform 101 to the edge platform 102. For example, an “alert pre-check” operation corresponds to a prediction to move the operation from the cloud platform 101 to the edge platform 102 with an 88% confidence. A “cases processor” operation and a “service ticket recommendation” operation correspond to predictions not to move the operations from the cloud platform 101 to the edge platform 102 with a 71% confidence and an 80% confidence, respectively. In some embodiments, the operations correspond to backend operations for an enterprise. However, the embodiments are necessarily limited thereto.

In one or more embodiments, the output prediction 820 including the confidence score is sent to an administrator via, for example, an administrator device 103. The combination of the prediction and the confidence score facilitates decision-making by administrators regarding operation relocation. In some embodiments, a recommendation to transfer execution of an operation from a cloud platform 101 to an edge platform 102 is sent from the orchestration engine 120-1 of the cloud platform 101 to the orchestration engine 120-2 of the edge platform 102. In some situations, the edge platform 102 replies to the cloud platform 101 with an acceptance of the transfer. In other cases, the edge platform 102 may reply to the cloud platform 101 with an indication that the edge platform 102 does not have enough resource capacity to accommodate the transfer and deny the transfer. The reply message can include, for example, resource capacity details (e.g., CPU, memory and storage usage or availability values) of devices of the edge platform 102. In some instances, in response to one or more requests that operations be transferred to the edge platform 102 from the cloud platform 101, the edge platform 102 may initiate vertical and/or horizontal scaling operations to increase resource capacity. For example, the edge platform 102 may automatically access and add more devices to process operations and/or automatically access and send operations to additional edge platforms for processing. In some instances, the edge platform 102 may be part of a cluster of edge platforms, where operations are distributed to nodes of the cluster.

In some scenarios, edge device resource availability data is received from the edge platform 102 by the cloud platform 101 and/or by an administrator device 103. Based at least in part on the edge device resource availability, a determination is made by the cloud platform 101 and/or an administrator whether to transfer the further execution of the machine learning algorithm from the cloud platform 101 to the edge platform 102.

According to one or more embodiments, the databases 113, 125, 130-1 and 130-2 and other databases referred to herein can be configured according to a relational database management system (RDBMS) (e.g., PostgreSQL). In some embodiments, the databases 113, 125, 130-1 and 130-2 and other databases referred to herein are implemented using one or more storage systems or devices associated with the cloud or edge platforms 101 and 102. In some embodiments, one or more of the storage systems utilized to implement the databases 113, 125, 130-1 and 130-2 and other databases referred to herein comprise a scale-out all-flash content addressable storage array or other type of storage array.

The term “storage system” as used herein is therefore intended to be broadly construed and should not be viewed as being limited to content addressable storage systems or flash-based storage systems. A given storage system as the term is broadly used herein can comprise, for example, network-attached storage (NAS), storage area networks (SANs), direct-attached storage (DAS) and distributed DAS, as well as combinations of these and other storage types, including software-defined storage.

Other particular types of storage products that can be used in implementing storage systems in illustrative embodiments include all-flash and hybrid flash storage arrays, software-defined storage products, cloud storage products, object-based storage products, and scale-out NAS clusters. Combinations of multiple ones of these and other storage products can also be used in implementing a given storage system in an illustrative embodiment.

The serviceability prediction engines 110-1 and 110-2, orchestration engines 120-1 and 120-2, and databases 130-1 and 130-2 in the FIG. 1 embodiment are each assumed to be implemented using at least one processing device. Each such processing device generally comprises at least one processor and an associated memory and implements one or more functional modules for controlling certain features of the serviceability prediction engines 110-1 and 110-2, orchestration engines 120-1 and 120-2, and/or databases 130-1 and 130-2.

At least portions of the cloud and edge platforms 101 and 102 and the elements thereof may be implemented at least in part in the form of software that is stored in memory and executed by a processor. The cloud and edge platforms 101 and 102 and the elements thereof comprise further hardware and software required for running the cloud and edge platforms 101 and 102, including, but not necessarily limited to, on-premises or cloud-based centralized hardware, graphics processing unit (GPU) hardware, virtualization infrastructure software and hardware, Docker containers, networking software and hardware, and cloud infrastructure software and hardware.

It is assumed that the cloud and edge platforms 101 and 102 in the FIG. 1 embodiment and other processing platforms referred to herein are each implemented using a plurality of processing devices each having a processor coupled to a memory. Such processing devices can illustratively include particular arrangements of compute, storage and network resources. For example, processing devices in some embodiments are implemented at least in part utilizing virtual resources such as virtual machines (VMs) or LXCs, or combinations of both as in an arrangement in which Docker containers or other types of LXCs are configured to run on VMs.

The term “processing platform” as used herein is intended to be broadly construed so as to encompass, by way of illustration and without limitation, multiple sets of processing devices and one or more associated storage systems that are configured to communicate over one or more networks.

As a more particular example, the serviceability prediction engines 110-1 and 110-2, orchestration engines 120-1 and 120-2, databases 130-1 and 130-2 and other elements of the cloud and edge platforms 101 and 102 can each be implemented in the form of one or more LXCs running on one or more VMs. Other arrangements of one or more processing devices of a processing platform can be used to implement the serviceability prediction engines 110-1 and 110-2, orchestration engines 120-1 and 120-2, databases 130-1 and 130-2, as well as other elements of the cloud and edge platforms 101 and 102. Other portions of the system 100 can similarly be implemented using one or more processing devices of at least one processing platform.

It is to be appreciated that these and other features of illustrative embodiments are presented by way of example only and should not be construed as limiting in any way. Accordingly, different numbers, types and arrangements of system elements such as the serviceability prediction engines 110-1 and 110-2, orchestration engines 120-1 and 120-2, databases 130-1 and 130-2 and other elements of the cloud and edge platforms 101 and 102, and the portions thereof can be used in other embodiments.

It should be understood that the particular sets of modules and other elements implemented in the system 100 as illustrated in FIG. 1 are presented by way of example only. In other embodiments, only subsets of these elements, or additional or alternative sets of elements, may be used, and such elements may exhibit alternative functionality and configurations.

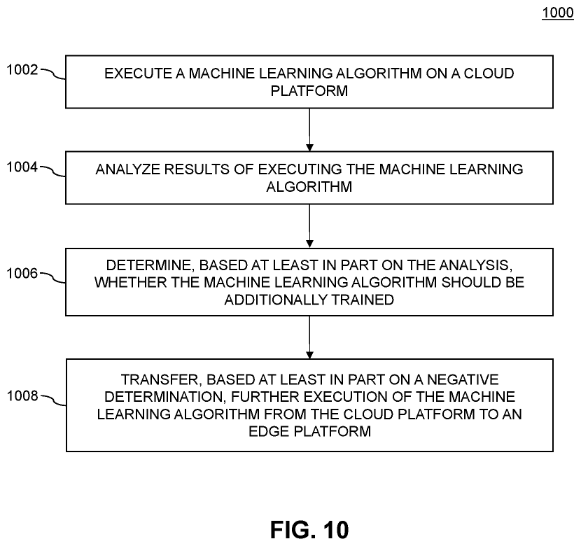

The operation of the information processing system 100 will now be described in further detail with reference to the flow diagram of FIG. 10. With reference to FIG. 10, a process 1000 for managing whether operations are performed at edge or cloud platforms as shown includes steps 1002 through 1008, and is suitable for use in the system 100 but is more generally applicable to other types of information processing systems configured for managing whether operations are performed at edge or cloud platforms.

In step 1002, a machine learning algorithm is executed on a cloud platform. In step 1004, the results of executing the machine learning algorithm are analyzed, and in step 1006, based at least in part on the analysis, a determination is made whether the machine learning algorithm should be additionally trained (e.g., requires additional training). In step 1008, based at least in part on a negative determination, further execution of the machine learning algorithm is transferred from the cloud platform to an edge platform. Based at least in part on the negative determination, a recommendation whether to transfer the further execution of the machine learning algorithm from the cloud platform to the edge platform is generated, wherein the recommendation comprises a confidence score and is transmitted to one or more user and/or administrator devices. The confidence score is computed using a conformal prediction model the recommendation is generated using one or more machine learning classifiers.

The analyzing of the results of executing the machine learning algorithm comprises computing a prediction error of the machine learning model over a period of time, wherein the computing of the prediction error of the machine learning algorithm over the period of time is performed for a testing dataset and a training dataset. A learning curve is generated based at least in part on the computed prediction error. A point on the learning curve corresponding to where the machine learning algorithm is between underfitting and overfitting the training dataset is identified, and the negative determination is made responsive to the identifying.

In response to the negative determination, a request that the further execution of the machine learning algorithm be performed on the edge platform is generated and is transmitted from the cloud platform to the edge platform.

Data corresponding to edge device resource availability is received from the edge platform by the cloud platform and/or by an administrator device. Based at least in part on the edge device resource availability, a determination is made by the cloud platform and/or an administrator whether to transfer the further execution of the machine learning algorithm from the cloud platform to the edge platform.

In an illustrative embodiment, data corresponding to an amount of data being processed by the machine learning algorithm on the cloud platform is received, and data corresponding to a frequency of requests for execution of the machine learning algorithm on the cloud platform is received. Based at least in part on the amount of data being processed by the machine learning algorithm, and/or based at least in part on the frequency of requests for execution of the machine learning algorithm, a determination is made whether to transfer the further execution of the machine learning algorithm from the cloud platform to the edge platform.

It is to be appreciated that the FIG. 10 process and other features and functionality described above can be adapted for use with other types of information systems configured to manage whether operations are performed at edge or cloud platforms.

The particular processing operations and other system functionality described in conjunction with the flow diagram of FIG. 10 are therefore presented by way of illustrative example only and should not be construed as limiting the scope of the disclosure in any way. Alternative embodiments can use other types of processing operations. For example, the ordering of the process steps may be varied in other embodiments, or certain steps may be performed at least in part concurrently with one another rather than serially. Also, one or more of the process steps may be repeated periodically, or multiple instances of the process can be performed in parallel with one another.

Functionality such as that described in conjunction with the flow diagram of FIG. 10 can be implemented at least in part in the form of one or more software programs stored in memory and executed by a processor of a processing device such as a computer or server. As will be described below, a memory or other storage device having executable program code of one or more software programs embodied therein is an example of what is more generally referred to herein as a “processor-readable storage medium.”

Illustrative embodiments of systems for managing whether operations are performed at edge or cloud platforms as disclosed herein can provide a number of significant advantages relative to conventional arrangements. For example, the embodiments provide a technical solution which determines whether a machine learning algorithm used in connection with an operation requires additional learning, and bases a decision to move the operation from a cloud platform to an edge platform on whether the machine learning algorithm requires additional learning.

Conventional approaches fail to provide techniques for predicting the need to move operations (e.g., services, tasks, workloads) from cloud to edge locations. As noted hereinabove, when using a cloud platform for processing operations, sending large amounts of data over a network to the cloud platform may consume large amounts of network bandwidth, create data privacy and security issues and create unwanted delay when quick solutions are needed. In addition, a centralized cloud platform may be a single point of dependency, which may have catastrophic consequences if the cloud platform fails. Advantageously, providing the ability to predict when operations should be transferred to edge locations and transferring data processing to edge locations results in reduced turnaround time, reduced cost, increased control, improved privacy and security, and more efficient use of compute resources when compared to systems that are limited to processing operations on a cloud platform.

Unlike conventional approaches, illustrative embodiments provide technical solutions which formulate programmatically and with a high degree of accuracy the capability to intelligently and proactively predict whether operations can be successfully transferred to edge locations for processing. The embodiments advantageously factor in whether machine learning algorithms have been adequately trained, the amount of data being processed by operations and the frequency of requests for operations before determining whether the operations should be moved from the cloud to the edge for execution.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As noted above, at least portions of the information processing system 100 may be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform that may be used to implement at least a portion of an information processing system comprise cloud infrastructure including virtual machines and/or container sets implemented using a virtualization infrastructure that runs on a physical infrastructure. The cloud infrastructure further comprises sets of applications running on respective ones of the virtual machines and/or container sets.

These and other types of cloud infrastructure can be used to provide what is also referred to herein as a multi-tenant environment. One or more system elements such as the cloud and edge platforms 101 and 102 or portions thereof are illustratively implemented for use by tenants of such a multi-tenant environment.

As mentioned previously, cloud infrastructure as disclosed herein can include cloud-based systems. Virtual machines provided in such systems can be used to implement at least portions of one or more of a computer system, a cloud platform and/or edge platform in illustrative embodiments. These and other cloud-based systems in illustrative embodiments can include object stores.

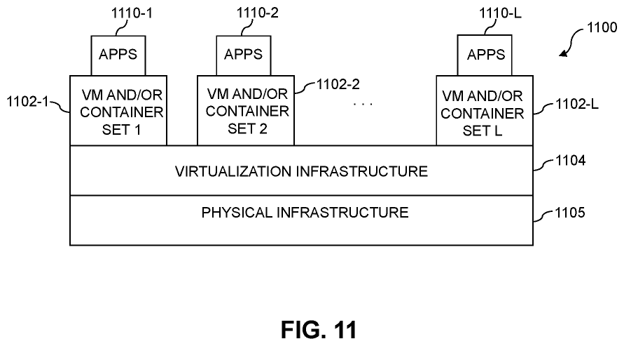

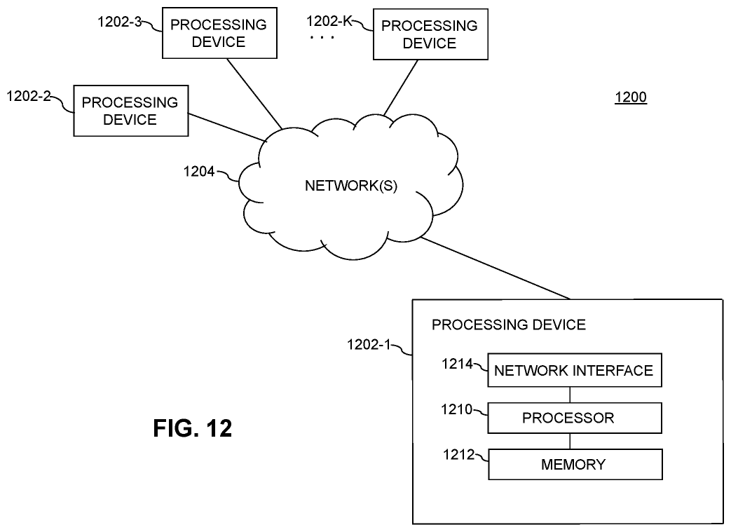

Illustrative embodiments of processing platforms will now be described in greater detail with reference to FIGS. 11 and 12. Although described in the context of system 100, these platforms may also be used to implement at least portions of other information processing systems in other embodiments.

FIG. 11 shows an example processing platform comprising cloud infrastructure 1100. The cloud infrastructure 1100 comprises a combination of physical and virtual processing resources that may be utilized to implement at least a portion of the information processing system 100. The cloud infrastructure 1100 comprises multiple virtual machines (VMs) and/or container sets 1102-1, 1102-2, . . . 1102-L implemented using virtualization infrastructure 1104. The virtualization infrastructure 1104 runs on physical infrastructure 1105, and illustratively comprises one or more hypervisors and/or operating system level virtualization infrastructure. The operating system level virtualization infrastructure illustratively comprises kernel control groups of a Linux operating system or other type of operating system.

The cloud infrastructure 1100 further comprises sets of applications 1110-1, 1110-2, . . . 1110-L running on respective ones of the VMs/container sets 1102-1, 1102-2, . . . 1102-L under the control of the virtualization infrastructure 1104. The VMs/container sets 1102 may comprise respective VMs, respective sets of one or more containers, or respective sets of one or more containers running in VMs.

In some implementations of the FIG. 11 embodiment, the VMs/container sets 1102 comprise respective VMs implemented using virtualization infrastructure 1104 that comprises at least one hypervisor. A hypervisor platform may be used to implement a hypervisor within the virtualization infrastructure 1104, where the hypervisor platform has an associated virtual infrastructure management system. The underlying physical machines may comprise one or more distributed processing platforms that include one or more storage systems.

In other implementations of the FIG. 11 embodiment, the VMs/container sets 1102 comprise respective containers implemented using virtualization infrastructure 1104 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element may be viewed as an example of what is more generally referred to herein as a “processing device.” The cloud infrastructure 1100 shown in FIG. 11 may represent at least a portion of one processing platform. Another example of such a processing platform is processing platform 1200 shown in FIG. 12.

The processing platform 1200 in this embodiment comprises a portion of system 100 and includes a plurality of processing devices, denoted 1202-1, 1202-2, 1202-3, . . . 1202-K, which communicate with one another over a network 1204.

The network 1204 may comprise any type of network, including by way of example a global computer network such as the Internet, a WAN, a LAN, a satellite network, a telephone or cable network, a cellular network, a wireless network such as a WiFi or WiMAX network, or various portions or combinations of these and other types of networks.

The processing device 1202-1 in the processing platform 1200 comprises a processor 1210 coupled to a memory 1212. The processor 1210 may comprise a microprocessor, a microcontroller, an application-specific integrated circuit (ASIC), a field-programmable gate array (FPGA), a central processing unit (CPU), a graphical processing unit (GPU), a tensor processing unit (TPU), a video processing unit (VPU) or other type of processing circuitry, as well as portions or combinations of such circuitry elements.

The memory 1212 may comprise random access memory (RAM), read-only memory (ROM), flash memory or other types of memory, in any combination. The memory 1212 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture may comprise, for example, a storage array, a storage disk or an integrated circuit containing RAM, ROM, flash memory or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1202-1 is network interface circuitry 1214, which is used to interface the processing device with the network 1204 and other system components, and may comprise conventional transceivers.

The other processing devices 1202 of the processing platform 1200 are assumed to be configured in a manner similar to that shown for processing device 1202-1 in the figure.

Again, the particular processing platform 1200 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

As indicated previously, components of an information processing system as disclosed herein can be implemented at least in part in the form of one or more software programs stored in memory and executed by a processor of a processing device. For example, at least portions of the functionality of one or more elements of the cloud and edge platforms 101 and 102 as disclosed herein are illustratively implemented in the form of software running on one or more processing devices.

It should again be emphasized that the above-described embodiments are presented for purposes of illustration only. Many variations and other alternative embodiments may be used. For example, the disclosed techniques are applicable to a wide variety of other types of information processing systems and cloud and edge platforms. Also, the particular configurations of system and device elements and associated processing operations illustratively shown in the drawings can be varied in other embodiments. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A method, comprising:
executing a machine learning algorithm on a cloud platform;
analyzing results of executing the machine learning algorithm;
determining, based at least in part on the analysis, whether the machine learning algorithm should be additionally trained; and
transferring, based at least in part on a negative determination, further execution of the machine learning algorithm from the cloud platform to an edge platform;
wherein the method is performed by at least one processing device comprising a processor coupled to a memory.

2. The method of claim 1, further comprising:
generating, in response to the negative determination, a request that the further execution of the machine learning algorithm be performed on the edge platform; and
transmitting the request from the cloud platform to the edge platform.

3. The method of claim 1, further comprising:
receiving data corresponding to edge device resource availability from the edge platform; and
determining, based at least in part on the edge device resource availability, whether to transfer the further execution of the machine learning algorithm from the cloud platform to the edge platform.

4. The method of claim 1, further comprising:
receiving data corresponding to an amount of data being processed by the machine learning algorithm on the cloud platform; and
determining, based at least in part on the amount of data being processed by the machine learning algorithm, whether to transfer the further execution of the machine learning algorithm from the cloud platform to the edge platform.

5. The method of claim 1, further comprising:
receiving data corresponding to a frequency of requests for execution of the machine learning algorithm on the cloud platform; and
determining, based at least in part on the frequency of requests for execution of the machine learning algorithm, whether to transfer the further execution of the machine learning algorithm from the cloud platform to the edge platform.

6. The method of claim 1, wherein the analyzing of the results of executing the machine learning algorithm comprises computing a prediction error of the machine learning algorithm over a period of time.

7. The method of claim 6, wherein the computing of the prediction error of the machine learning algorithm over the period of time is performed for a testing data set and a training data set.

8. The method of claim 7, further comprising generating a learning curve based at least in part on the computed prediction error.

9. The method of claim 8, further comprising:
identifying a point on the learning curve corresponding to where the machine learning algorithm is between underfitting and overfitting the training data set; and
making the negative determination responsive to the identifying.

10. The method of claim 1, further comprising generating, based at least in part on the negative determination, a recommendation whether to transfer the further execution of the machine learning algorithm from the cloud platform to the edge platform, wherein the recommendation comprises a confidence score.

11. The method of claim 10, wherein the confidence score is computed using a conformal prediction model.

12. The method of claim 10, wherein the recommendation is generated using one or more machine learning classifiers.

13. The method of claim 10, further comprising transmitting the recommendation to one or more user devices.

14. An apparatus, comprising:
at least one processor and at least one memory storing computer program instructions wherein, when the at least one processor executes the computer program instructions, the apparatus is configured:
to execute a machine learning algorithm on a cloud platform;
to analyze results of executing the machine learning algorithm;
to determine, based at least in part on the analysis, whether the machine learning algorithm should be additionally trained; and
to transfer, based at least in part on a negative determination, further execution of the machine learning algorithm from the cloud platform to an edge platform.

15. The apparatus of claim 14, wherein, in analyzing the results of executing the machine learning algorithm, the apparatus is further configured to compute a prediction error of the machine learning algorithm over a period of time.

16. The apparatus of claim 15, wherein the apparatus is further configured to generate a learning curve based at least in part on the computed prediction error.

17. The apparatus of claim 16, wherein the apparatus is further configured:
to identifying a point on the learning curve corresponding to where the machine learning algorithm is between underfitting and overfitting a training data set; and
to make the negative determination responsive to the identifying.

18. A computer program product stored on a non-transitory computer-readable medium and comprising machine executable instructions, the machine executable instructions, when executed, causing a processing device:
to execute a machine learning algorithm on a cloud platform;
to analyze results of executing the machine learning algorithm;
to determine, based at least in part on the analysis, whether the machine learning algorithm should be additionally trained; and
to transfer, based at least in part on a negative determination, further execution of the machine learning algorithm from the cloud platform to an edge platform.

19. The computer program product of claim 18, wherein, in analyzing the results of executing the machine learning algorithm, the machine executable instructions further cause the processing device to compute a prediction error of the machine learning algorithm over a period of time.

20. The computer program product of claim 19, wherein the machine executable instructions further cause the processing device to generate a learning curve based at least in part on the computed prediction error.
